(19) United States
(12) Patent Application Publication
(10) Pub. No.: US 2003/0224648 A1
(43) Pub. Date: Dec. 4, 2003

(54) Connector in combination with a circuit board so as to have an electrical connection with an integrated circuit

(76) Inventor: Li-Ling Cheng, Taipei (TW)

Correspondence Address: Jones, Tullar & Cooper, P.C., Suite 1002, 2001 Jefferson Davis Highway, Arlington, VA, 22202, US

(21) Appl. No.: 10/154,833

(22) Filed: May 28, 2002

(51) Int. Cl. H01R 13/625

(52) U.S. Cl. 439/342

(57) ABSTRACT

A connector has multiple through holes defined to receive therein connection pins each having a bent extending out from a bottom face of the connector. A circuit board has multiple connecting bosses each having a solder ball formed thereon to correspond to the extended bent of each of the connection pins so that the connection between the connector and the circuit board is readily accomplished.

### BACKGROUND OF THE INVENTION

1. Field of the Invention

The present invention relates to a connector in combination with a circuit board, and more particularly to a connector in combination with a circuit board so that an electrical connection between the circuit board and an integrated circuit is achieved via the connector.

2. Description of Related Art

A conventional connector (70), shown in FIG. 5, has multiple sockets (72) each defined for receiving therein a connecting pin (74). Each of the connecting pins (74) engages with an integrated circuit (80) at a free end thereof.

When an integrated circuit (not shown) is mounted on top of the connector (70), an electrical connection with the circuit board (80) is accomplished by means of the connection pins (74).

With reference to FIGS. 6 and 7, each connection pin (74) has a bent (742) on the free end thereof so that when the connector (70) is to be connected to the circuit board (80), the bent (742) is welded to a corresponding one of a connecting boss (82) formed on a face of the circuit board (80). However, it is to be noted that the bents (742) of the connection pins (74) do not protrude out of the connector (70) so that direct connection between the connector (70) and the circuit board (80) is almost impossible. Manufacturers will have to think of other alternatives. Accordingly, a solder ball (824) in combination with a solder paste (because the solder paste is formed with the connecting boss, the solder paste is not shown) is formed on top of each of the connecting bosses (82) so that when the connection pins (74) are to be connected to the connecting bosses (82), the manufacturers are able to align each of the connection pins (74) with the corresponding one of the connecting bosses (82). Then, melting the solder paste is able to have a secure connection between connecting pins (74) and the solder balls (824) and therefore an electrical engagement is achieved between the connector (70) and the circuit board (80).

Even though using the solder balls (824) to have an electrical connection between the circuit board (80) and the integrated circuit (not shown) does meet the requirements, drawbacks come along with the satisfaction.

It is well known in the art that an electrical connection should be as pure as possible, otherwise the electrical connection will be damaged in a certain degree. Therefore, when referring back to the connection between the connector (70) and the circuit board (80), it is seen that the electrical connection is based on the solder balls (824). When the solder balls (824) are melted, a part of the vaporized tin from the solder balls (824) will attach to the connection pins (74), which interferes the electrical performance of the connection pins (74).

Furthermore, because alignment is crucial in the connection between the connector (70) and the circuit board (80) in this conventional structure, manufacturers will have to use different auxiliary devices to secure the alignment between the connector (70) and the circuit board (80), otherwise, the alignment will shift due to the light weight material used to make the connector (70).

To overcome the shortcomings, the present invention tends to provide an improved connector and circuit board to mitigate and obviate the aforementioned problems.

### SUMMARY OF THE INVENTION

The primary objective of the present invention is to provide a connector in combination with a circuit board so that an electrical connection with the integrated circuit is readily achieved.

Another objective of the present invention is to have positioning poles formed on a bottom face of the connector so that the connector is able to have solid connection with the circuit board.

In order to accomplish the foregoing objective, the connector constructed in accordance with the present invention has connection pins extending out form a bottom face of the connector so that welding bosses are eliminated so reduce the interference to the electrical connection between the connection pins and the circuit board. Moreover, the connector has positioning poles extending out of the bottom face of the connector to correspond to positioning holes in the circuit board. Therefore, when the connector is connected to the circuit board, the positioning poles extending into the corresponding positioning holes will secure the alignment between the connector and the circuit board.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the connector with a covering and an integrated circuit;

FIG. 2 is a schematic cross sectional view showing the connection between the connector and the circuit board;

FIG. 3 is an enlarged partial perspective view of the connector of the present invention;

FIG. 4 is a schematic view showing the detachment between the connection pins of the connector and connection legs of the integrated circuit;

FIG. 4A is a schematic view showing the attachment between the connection pins of the connector and connection legs of the integrated circuit;

FIG. 5 is a schematic cross sectional view showing a conventional connector in connection with a circuit board;

FIG. 6 is schematic cross sectional view showing that the conventional connection pins are to be connected to the circuit board via welding bosses on a face of the circuit board; and

FIG. 7 is a schematic cross sectional view showing that the welding bosses in FIG. 6 are welded so as to connect the connection pins of the connector to the circuit board.

### DETAILED DESCRIPTION OF THE PREFERRED EMBODIMENT

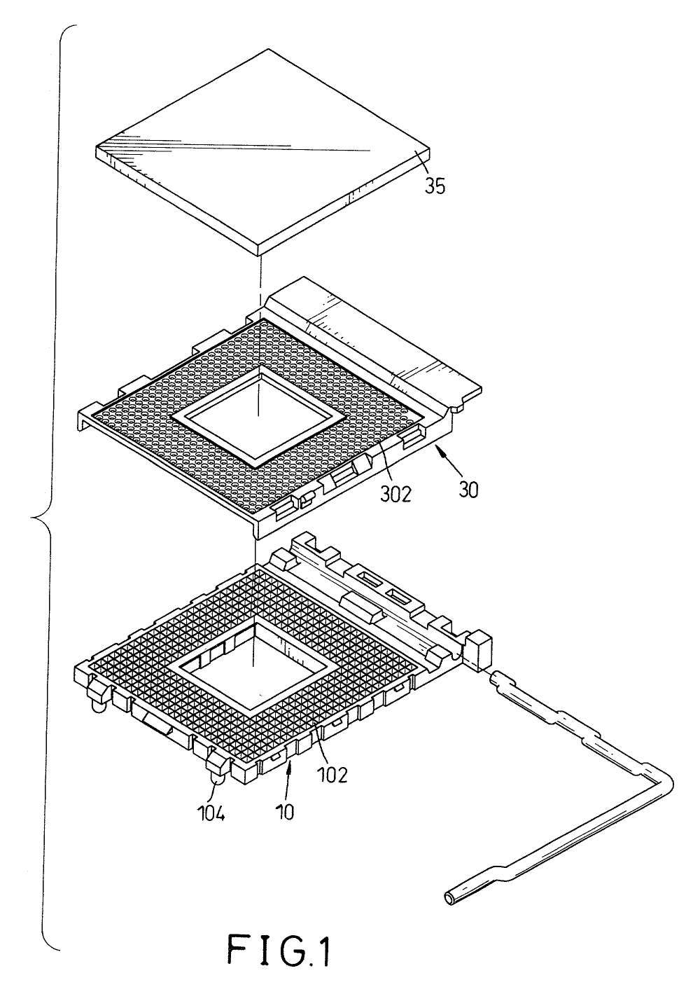

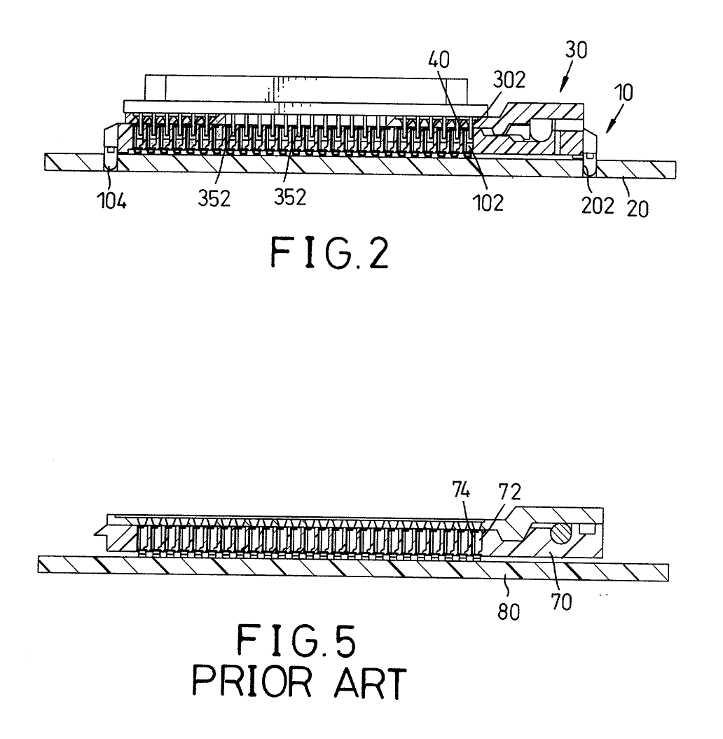

With reference to FIGS. 1 and 2, a connector (10) in accordance with the present invention is to be connected to a circuit board (20) and has multiple through holes (102) defined for securely receiving therein connection pins (40). A covering (30) is provided on top of the connector (10) and has holes (302) defined to correspond to the through holes (102) of the connector (10). An integrated circuit (35) (such as a central processing unit, CPU) having multiple connection legs (352) is provided on top of the covering (30) and the connection legs (352) are connected to the connection pins (40).

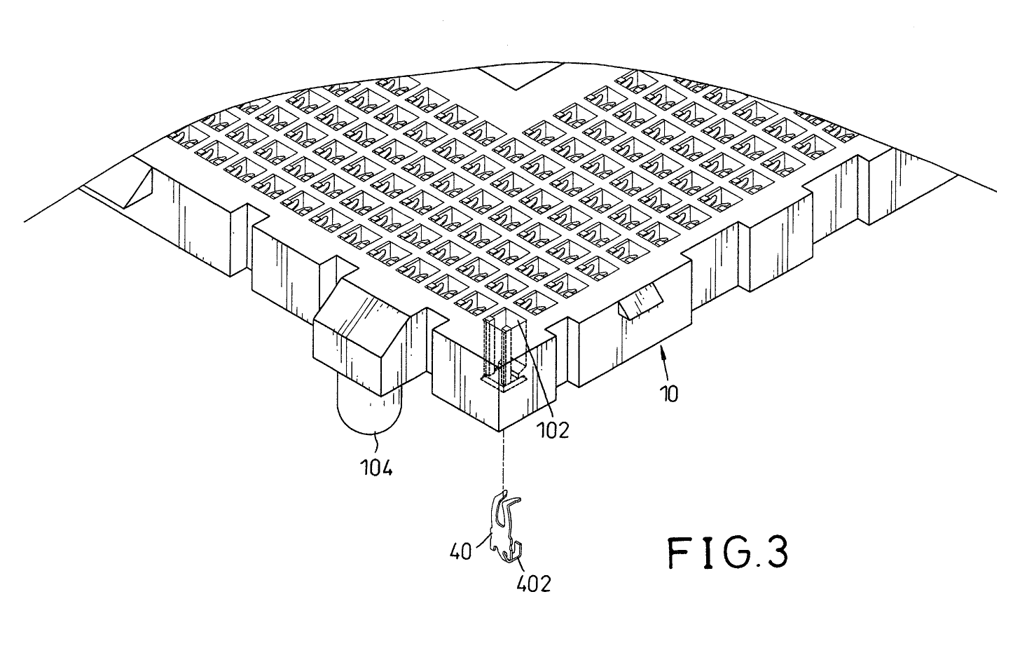

With reference to FIG. 3 and still taking FIG. 2 for reference, each connection pin (40) has a bent (402) extending out from a bottom face of the connector (10). The connector (10) further has multiple positioning poles (104) extending out from the bottom face of the connector (10) to correspond to positioning holes (202) on the circuit board (20).

It is noted that with the positioning poles (104) extending from the connector (10) and into the positioning holes (202) in the circuit board (20), the engagement between the connector (10) and the circuit board (20) is secured.

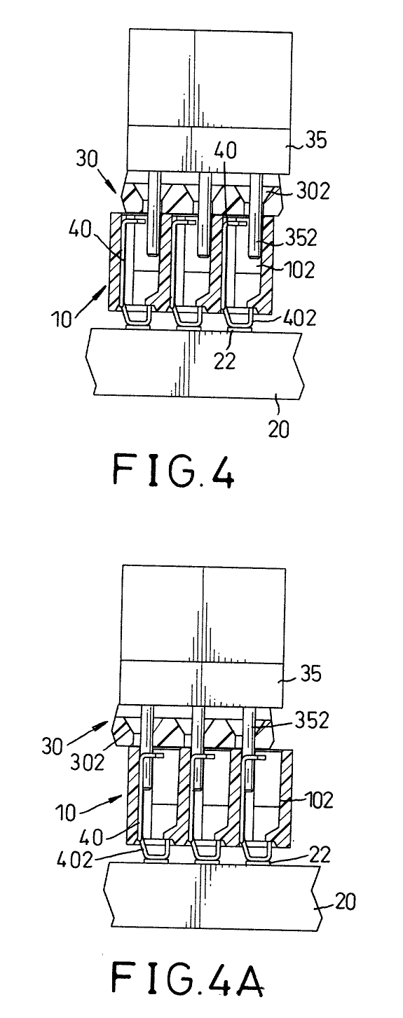

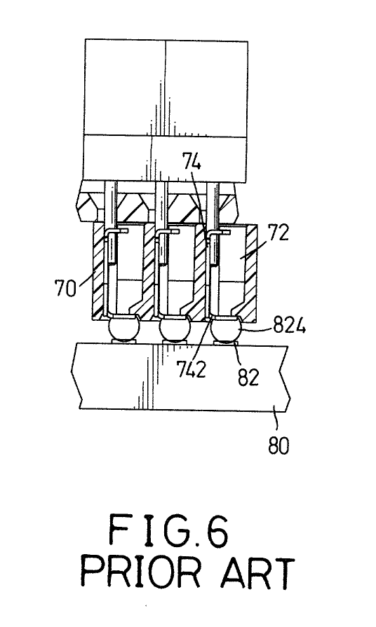

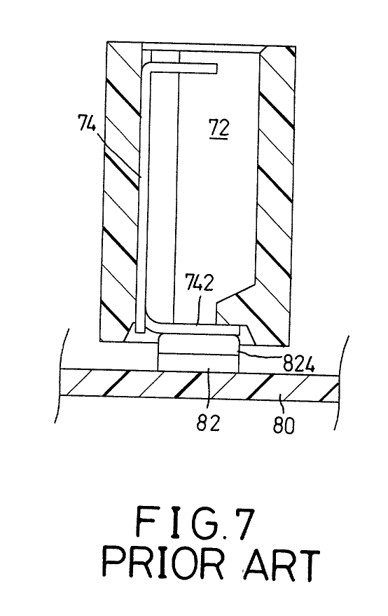

With reference to FIGS. 4 and 4A, it is further noted that with the positioning poles (104) and the positioning holes (202), the alignment between the connection pins (40) and connecting bosses (22) formed on one side face of the circuit board (20) is secured and therefore, the manufacturers are able to apply direction connection between the connector (10) and the circuit board (20) via the connection pins (40) and the connecting bosses (22). FIG. 4 shows that the connection legs (352) of the integrated circuit (35) is disengaged with the connection pins (40) and FIG. 4A shows that the connection legs (352) are engaged with the connection pins (40).

Alternatives of the present invention may be made by forming the positioning poles on the circuit board and the positioning holes in the connector, however, such alternative should still be in the scope of protection of the claims.

It is concluded from the foregoing description that the present invention eliminates the necessity of using auxiliary tools to stabilize the alignment between the connector and the circuit board so as to dramatically reduce the manufacture cost. Besides, because direct connection between the connector and the circuit board is readily accomplished via the connection pins and the connecting bosses, the interference to the electrical performance of the connecting pins is greatly enhanced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the fill extent indicated by the broad general meaning of the terms in which the appended claims are expressed.

What is claimed is:

1. A connector in combination with a circuit board in order to have an electrical connection to an integrated circuit,
wherein the connector comprising:
multiple through holes defined to receive therein connection pins each having a bent extending out from a bottom face of the connector, and
wherein the circuit board having multiple connecting bosses each having a solder ball formed thereon to correspond to the extended bent of each of the connection pins so that the connection between the connector and the circuit board is readily accomplished.

2. The connector in combination with the circuit board as claimed in claim 1, wherein the connector has multiple positioning poles extending from the bottom face of the connector to correspond to positioning holes in the circuit board so as to position relative position between the connector and the circuit board.
